(19) United States
(12) Patent Application Publication
(10) Pub. No.: US 2013/0124323 A1
(43) Pub. Date: May 16, 2013

(54) String Based Promotional System and Method Thereof

(71) Applicants: Charles A. Meyer, Irving, TX (US); Jason A. Snyder, Hoboken, NJ (US)

(72) Inventors: Charles A. Meyer, Irving, TX (US); Jason A. Snyder, Hoboken, NJ (US)

(73) Assignee: GOPOGO, LLC, Irving, TX (US)

(21) Appl. No.: 13/465,688

(22) Filed: May 7, 2012

Related U.S. Application Data
(60) Provisional application No. 61/483,373, filed on May 6, 2011.

(51) Int. Cl. G06Q 30/02

(52) U.S. Cl. CPC G06Q 30/0269
USPC 705/14.58; 705/14.66

(57) ABSTRACT

A system for associating a promotion with strings with the string being based upon a plurality of places and a relationship between two or more of those places. The strings represent an authentic user experience of a quality, character, and/or feel intended by the string author. The user experience can be further enhanced or guided through a narrative accompanying the string or places, written by the string author, that describes or invokes the quality, character or feel of the experience intended by the author. The promotions system promotes and suggests places, relationships, or strings that a user may want to experience based upon selections made by the user.

### RELATED APPLICATION DATA

This application claims priority to U.S. Provisional Patent Application Ser. No. 61/483,373, filed May 6, 2011, and titled “Geo-Location Based Playlist System and Method” which is incorporated by reference herein in its entirety.

### FIELD OF THE INVENTION

The present invention generally relates to the field of web-based socially linked promotion systems and methods. In particular, the present invention is directed to a computerized system and method of linking promotions to strings, or portions of strings.

### BACKGROUND

The ability to share various pieces of information between individuals has increased dramatically in the digital age with the advent of various devices and computer programs that allow for near real-time knowledge about an individual's activities and whereabouts. While the information shared by authors may be distributed widely, the information is often fragmented and disjointed, robbing authors and receivers of the information of a more complete understanding of the experience the author is attempting to disseminate.

Various websites and applications adapted for mobile computing devices (“apps”) allow users to search and locate activities and places of interest. In some cases, an app used in conjunction with a mobile device having geolocation functionality may provide a display of activities (e.g., a movie) or places (e.g., a restaurant) of interest in relationship to the present location of the mobile device. Many known websites and apps search for, and locate, activities of interest when a static query is initiated by the user. Recommendations from this static query may be selected based on geographic proximity to the location of the mobile device.

For example, the Facebook® system allows users to periodically update a profile status, which may include a statement of current thoughts, an article the user is reading, a location the person is at, pictures the person has taken, and so forth. Facebook allows users to connect with other persons to create a social network, the other persons being able to view and comment on the profile status of the user. The user can also receive the commentary of others in his or her network in time-sequence, thereby placing the most recent content of a person in the user's network as the first item to be reviewed by the user. The structure and organization of Facebook thereby allow for a review of a recent activity of a person by others, but fails to provide any connection between a multitude of activities of a user, which, when combined, disclose a more detailed and enriching experience.

### SUMMARY OF THE DISCLOSURE

In a first aspect a promotion system in accordance with the present disclosure is described for connecting a consumer to a promotion, the promotion system comprises: a computer-readable storage medium having a database and executable computer program instructions for electronic analysis of a plurality of places stored in the database, the computer program instructions including: a string module configured to develop at least one relationship for respective groups of the plurality of places; and a promotions module configured to determine a preferred string from a plurality of strings, the preferred string including at least two of the plurality of places and to associate a promotion with one or more places included with the preferred string.

In another aspect, a method of identifying potential consumers of a product or service using a database including a plurality of groups of places is described, the method comprising: generating a relationship for each of the plurality of groups of places; determining a preferred group from among the plurality of groups of places; and associating the preferred group with one or more promotions for products or services related to places within the preferred group.

In yet another aspect, a promotion system is described that comprises: a mobile device including a computer-readable storage medium having a database and executable computer program instructions for electronic analysis of a groups of places stored in the database, the computer program instructions including: a geolocation module configured to determine a location of the mobile device; a promotions module configured to determine a preferred group based upon the location of the mobile device and to associate a promotion with one or more places included with the preferred group.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of an information system suitable for implementing a location based promotion system (LBPS) according to an embodiment of the present invention;

FIG. 1A is a schematic representation of a device including components of a mobile LBPS according to an embodiment of the present invention;

FIG. 2 is a block diagram of a taxonomy system according to an embodiment of the present invention;

FIG. 3 is a block diagram of a hierarchical organizational structure for strings according to an embodiment of the present invention;

FIG. 4 is a histogram of string frequency according to an embodiment of the present invention;

FIG. 5 is a schematic representation of a mobile device suitable for use with a LBPS according to an embodiment of the present invention;

FIG. 6 is another schematic representation of a mobile device suitable for use with a LBPS according to an embodiment of the present invention;

FIG. 7 is yet another schematic representation of a mobile device suitable for use with a LBPS according to an embodiment of the present invention;

FIG. 8 is a further schematic representation of a mobile device suitable for use with a LBPS according to an embodiment of the present invention;

FIG. 9 is a further schematic representation of a mobile device suitable for use with a LBPS according to an embodiment of the present invention;

FIG. 10 is a flow diagram of a method of creating a string using a mobile device according to an embodiment of the present invention;

FIG. 11 is a flow diagram of a method of associating a promotion with a preferred string, group of places, or relationship, according to an embodiment of the present invention; and

FIG. 12 is a schematic representation of a computing system suitable for use with a LBPS according to an embodiment of the present invention.

### DETAILED DESCRIPTION

A location based promotion system of the present invention associates a promotion having certain characteristics with strings, places within strings, groups of places, or relationships, based upon those characteristics. Strings are combinations of two or more places and a relationship. The relationship for each string is generated so as to establish an association between the two or more places that, when performed, create or allow for the re-creation of an authentic user experience. The user experience can be further enhanced or guided through a narrative accompanying the string of places, written by the string author, that describes or invokes the quality, character, or feel of the experience intended by the author. The features of the string giving rise to the authentic user experience can be used by the location based promotion system to provide promotions to users for goods and services that relate to the authentic user experiences. The promotion can be presented to a user when the user selects a place that is part of a string, an entire string containing the place, or inputs another characteristic that is similar to the relationship attributed to a string.

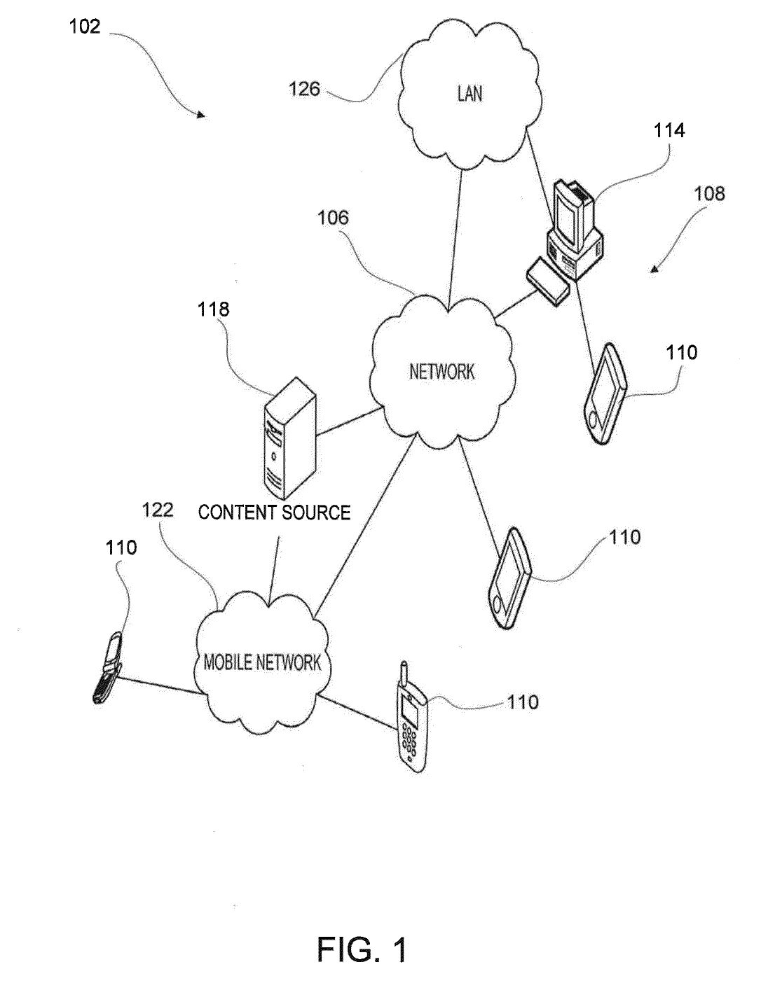

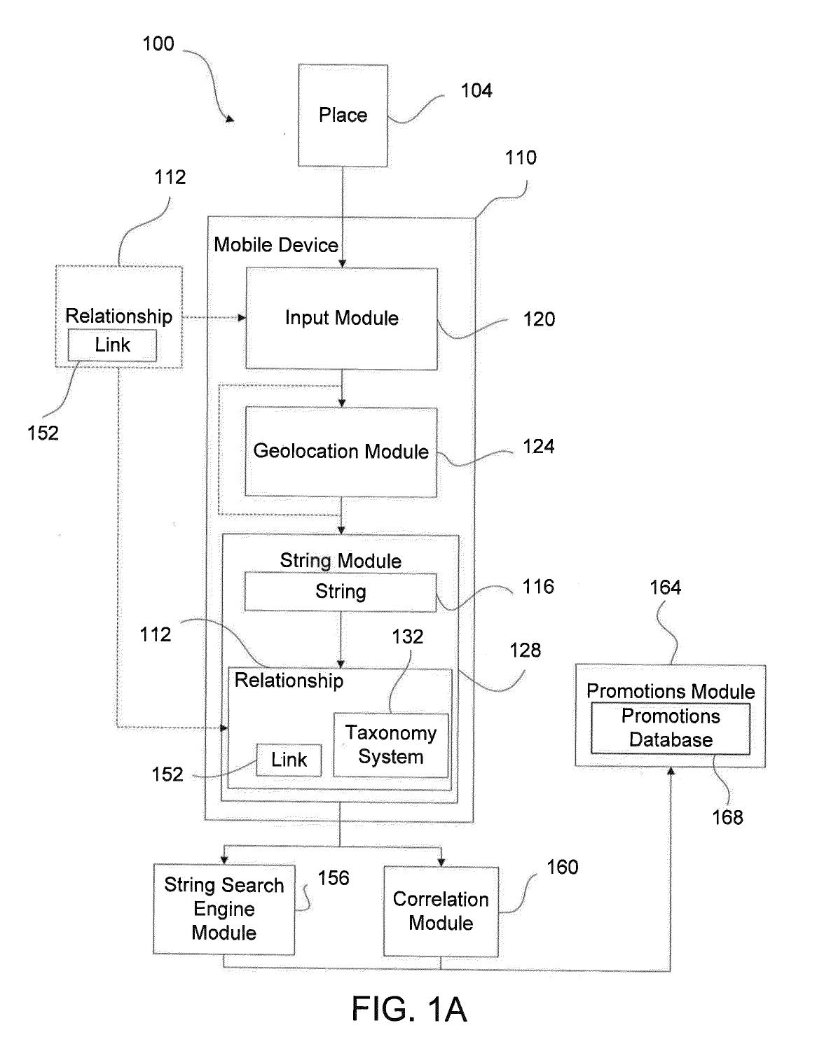

FIG. 1A illustrates an embodiment of a location based promotion system (LBPS) 100 configured to interact with the information system 102 of FIG. 1. Information system 102 may be used to communicate a wide variety of content, information, and/or data between components of information system 102, the content or information including, but not limited to, user preferences, user situational factors, including time, date, weather, and user location, promotions, or other information and content that can influence the character and performance of a string.

In an exemplary embodiment, information system 102 includes a network 106 and one or more computing apparatuses 108 such as mobile devices 110 or computing devices 114 that can include some or all of LBPS 100. Mobile device 110 can be a device, such as, but not limited to, a smartphone, global positioning system (GPS) device, or may be a pad or a tablet computing device, a smart book, a net book, a laptop, and other devices with geolocation functionality that may be moved from one location to another without significant inconvenience. Computing devices 114 can be a device, such as, but not limited to, desktop computers, servers, computer kiosks, or other devices that are not easily moved from one location to another.

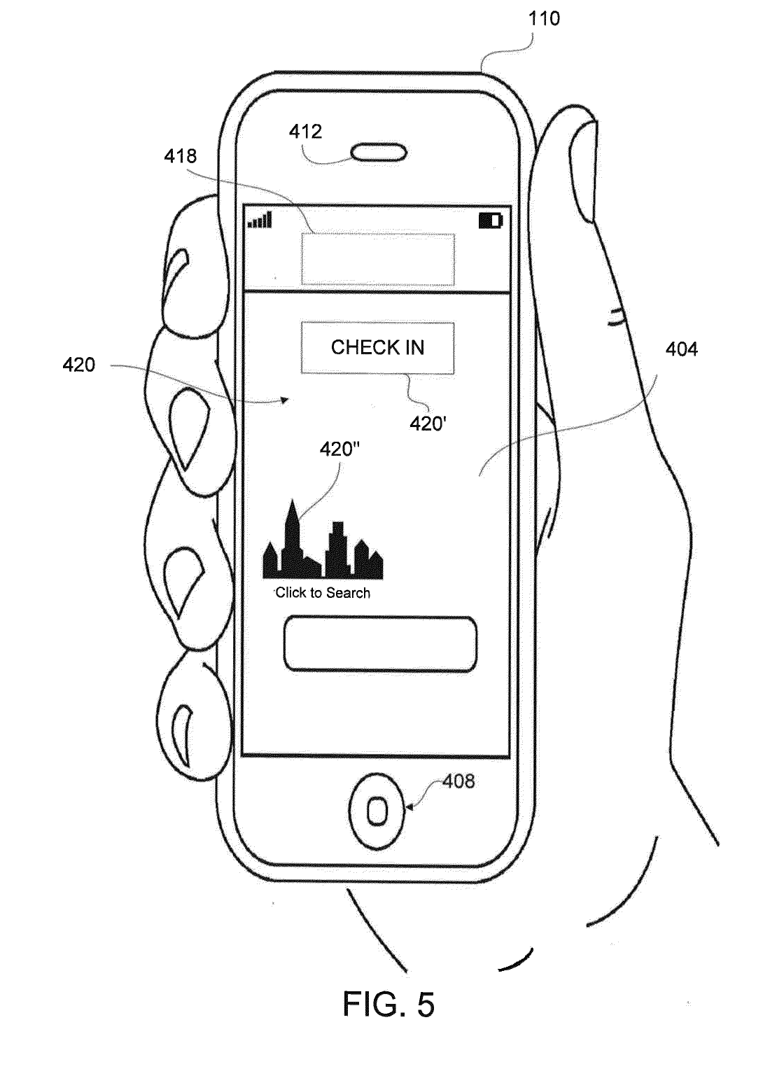

LBPS 100 may be accessed on or interacted with mobile device 110 by, for example, a user performing an overt action with respect to a user-interface element (discussed further below with reference to FIGS. 5-9) on the mobile device, such as touching an element or clicking on an element on the mobile device screen so as to indicate that place 104 being selected is the location of the mobile device at the time the overt action is taken. Mobile device 110 may communicate with one or more components of information system 102, such as, but not limited to, other mobile devices 110, a content source 118, and one or more computing devices 114. Mobile device 110 may communicate to the aforementioned devices through network 106, mobile network 122, and/or local area network (LAN) 126, so as to access, record, store, or retrieve information, such as place, user, string, and/or or relationship information (discussed in detail below with reference to FIG. 1A), in content source 118. Content source 118 can be, for example, a machine readable storage medium or a database, whether publicly accessible, privately accessible, or accessible through some other arrangement such as subscription, that holds, for example, information, data, programs, algorithms, or computer code, which is thereby accessible by mobile device 110.

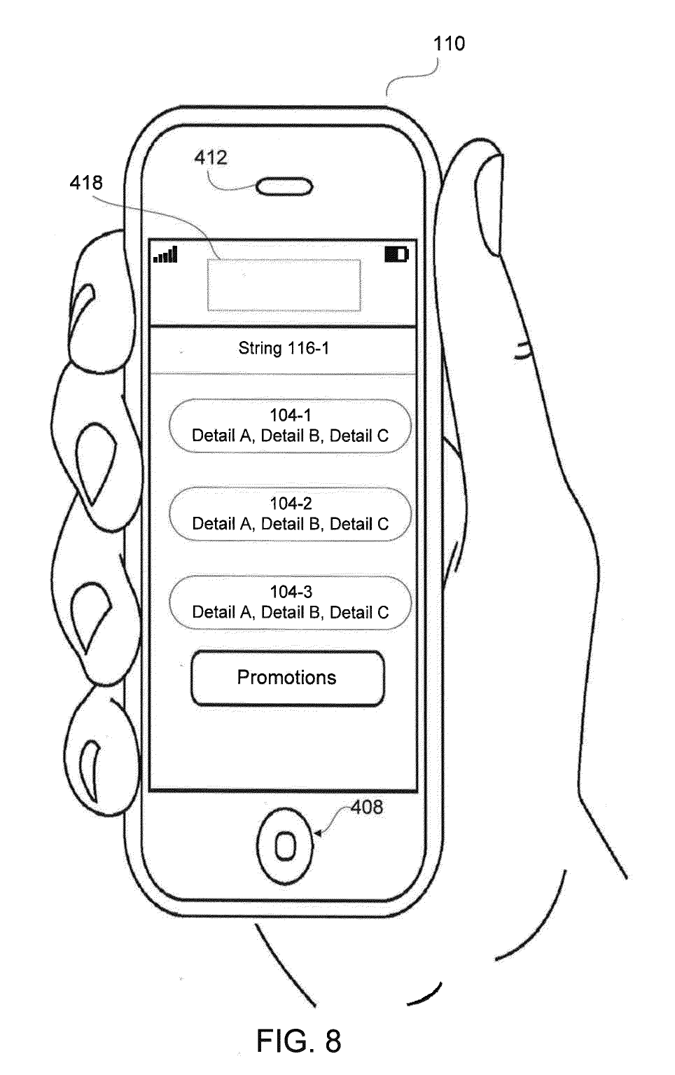

As those skilled in the art will appreciate, computing device 114 (discussed further below with reference to FIG. 8) may take a variety of forms, including, but not limited to, a server computer, a web appliance, a laptop computer, a desktop computer, a computer workstation, a terminal computer, web-enabled televisions, media players, and other computing devices in communication with network 106. LBPS 100 may be accessed on or interacted with computing device 114 by, for example, a user performing an overt action with respect to a web-based interface provided through network 106, such as clicking on an map or list or typing in a location so as to indicate the selection of place 104. Computing device 114 communicate with one or more components of information system 102, such as, but not limited to, other mobile devices 110, a content source 118, and other computing devices.

Network 106 may be used in connection with information system 102 to enable communication between the various elements of the information system that can include elements of LBPS 100. For example, as indicated in FIG. 1, network 106 may be used by mobile device 110 to communicate with content source 118 for storing and retrieving information needed by LBPS 100. Network 106 may also allow mobile device 110 to access certain software, algorithms, or other programs included with computing device 114. Those skilled in the art will appreciate that mobile device 110 can access information system 102 using any of a number of possible technologies including a cellular network, WiFi, wired internet access, combinations thereof, as well as others not recited, and for any of a number of purposes including, but not limited to, those reasons recited above.

LBPS 100 may also use an information system as discussed in U.S. Provisional Application No. 61/483,373, filed May 6, 2011, and titled “Geo-Location Based Playlist System and Method,” to Meyer, to communicate between modules include with the LBPS. U.S. Provisional Application No. 61/483,373 is incorporated by reference for its discussion of the same. In an embodiment, communication between the modules included with LBPS 100 (discussed in detail below with reference to FIG. 1A) may be initiated through a webpage or application accessible on mobile device 110. The website or application may be instantiated in a web-based environment existing on a web-page that is accessible through an information network, such as network 106. Mobile device 110 may also use the information network to facilitate communication between the mobile device and a content source, such as content source 118.

Turning now to FIG. 1A, LBPS 100 includes one or more software modules configured to allow for the designation of a place 104 by a user via a mobile device 110 or a computing device 114, the generation of strings based upon the locations designated by the user, the assignment of relationships to the strings, the determination of preferred relationships from among strings that share one or more places, and the association of promotions to the places associated with the preferred string, group, or relationship. As discussed further below, one or more of the modules included with LBPS 100 facilitates the input of a designation of place 104 that the user is at, wishes to be at, or has been at before.

The location of place 104 may be any geolocatable position, thereby allowing an author to enhance the experience by designating a unique place that is associated with other places the author wishes to include in his or her experience. Two or more of places 104 can then be assembled and be given or attributed a relationship 112, so as to create a string 116. In this way, a user may review, revise, distribute to other connections (e.g., other persons part of the user's social network), allow to be viewed or searched, his or her strings 116 and provide an indication of the relationship associated with the string so as to enrich the experience for the others viewing, editing, or wishing to recreate the string. In an embodiment, string 116 may be considered a social media object, the social media object being communicable between others in the user's social network and/or creating a link for others to converge on a discussion or participation of the string.

In an exemplary embodiment, LBPS 100 includes an input module 120, a geolocation module 124, and a string module 128. Input module 120 allows for inputting data, e.g., place 104, from a user into LBPS 100. Input module 120 can also permit a user to designate any geolocatable place as a location. As noted, a user may designate the location of place 104 on mobile device 110 or on computing device 114 by ways known in the art, such as, but not limited to, touching a spot on a touch screen, voicing a command, or directing a trackball or pointer.

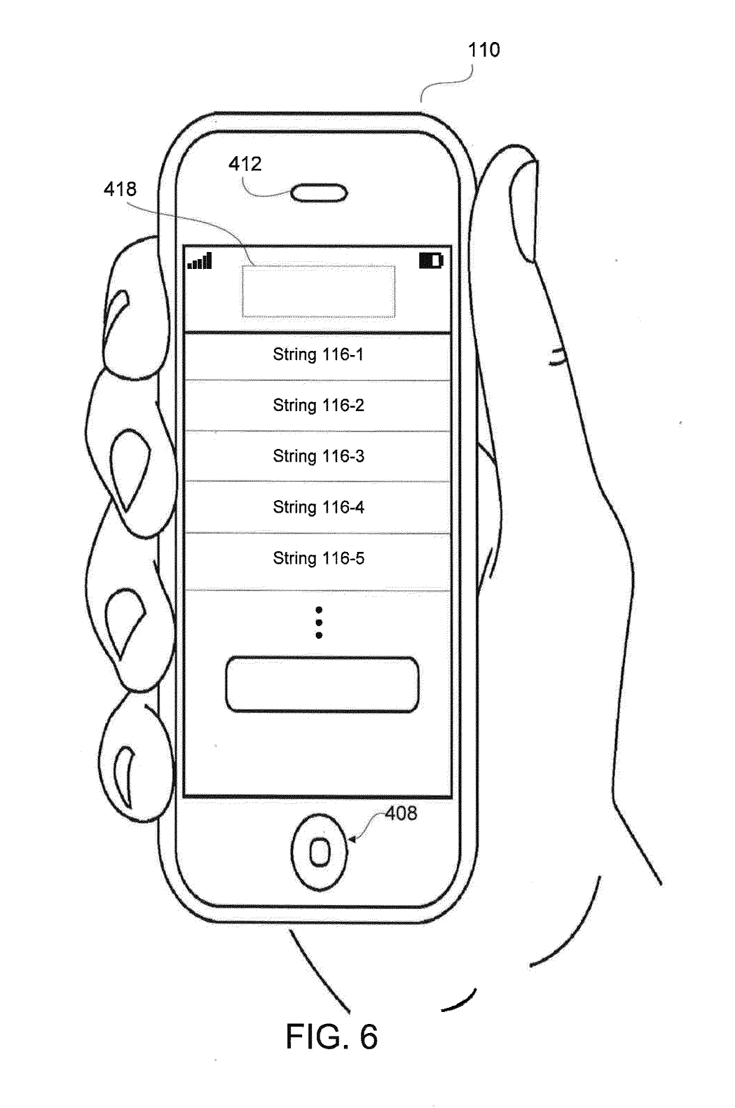

Input module 120 also allows for the selection of a predefined place or preexisting string from a list of places or strings having a geolocation proximate the user or a point designated by the user. For example, and as described in further detail with reference to FIGS. 5-9, a user may select, by touching an element or clicking on an element on the screen of mobile device 110, a string 116 from a list of strings. Strings 116 in the list of strings (e.g., strings 116-1 through 116-5 (FIG. 6)) may be provided based on the location of the user or based upon a desired location of the user, one or more of which may be selected by the user using input module 120. Similarly, a list of places 104 may be presented to the user for selection using input module 120.

Input module 120 may also allow a user to include other related information to geolocatable place 104. For example, a user may input a time of arrival at place 104, an experience the user had at the place, the type of event occurring at the place, and the like. A person of ordinary skill in the art should understand that some of the aforementioned pieces of related information may be generated automatically when the user designates place 104. For example, if the user designates geolocatable place 104 on mobile device 110, e.g., by tapping a user interface element with a command such as “Record This,” the mobile device may concomitantly record the geolocation of the mobile device and a time-stamp associated with the designation. The data input by a user into input module 120 may be stored in a database (described further below with reference to FIG. 8) for later retrieval or processing.

Geolocation module 124 is configured to act upon the request of the user, via input module 120, so as to identify and record the location of place 104, which in some embodiments may be a pair of coordinates (i.e., latitudinal and longitudinal) representative of the location of the user, the location of mobile device 110, an address of a business, an event location, a website address, or other addressable or geolocatable places. It should be appreciated by those of ordinary skill in the art that location information can be obtained in a number of different ways. For example, location information can be retrieved via global positioning system (GPS) technology. In another example, a user carrying mobile device 110 may be identified by a component of a mobile network (e.g., a location server, a presence server, a router, etc.) that mobile device 110 is connected to. In another example, triangulation techniques using multiple cell towers can be used to determine mobile device 110 location information. In yet another example, satellite locating techniques can be utilized to determine location information associated with mobile device 110.

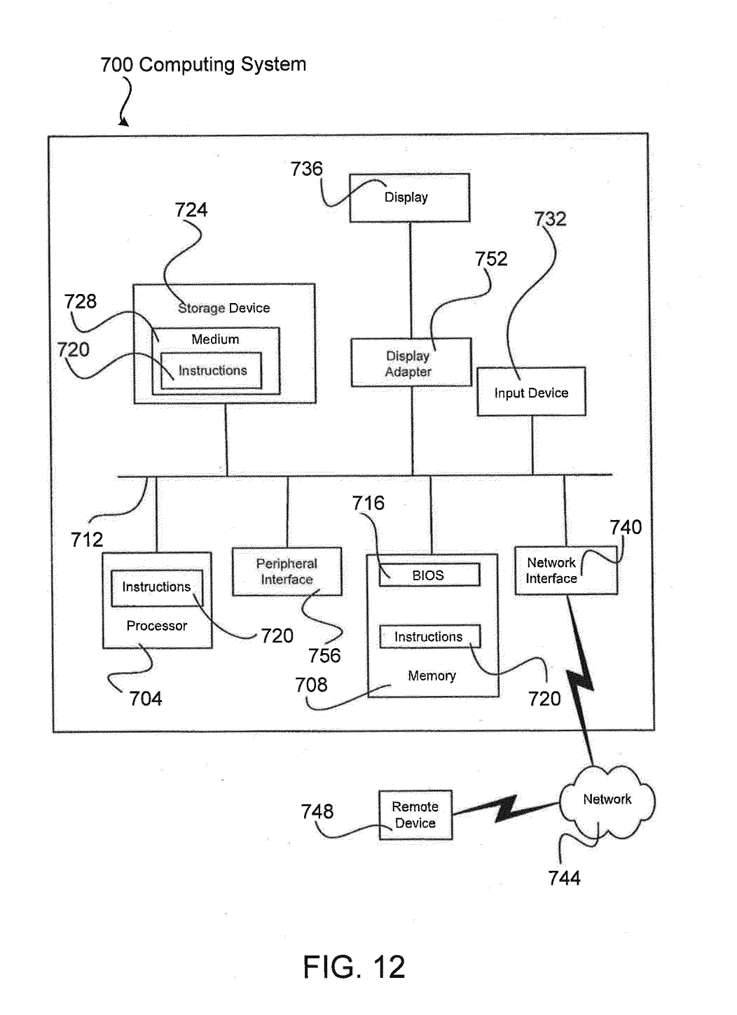

In an embodiment, mobile device 110 includes technology for determining its location or ascertaining information associated with its location. Mobile device 110 can then communicate that information to another entity, such as one or more networks 106, 122, or 126 (FIG. 1), or another entity can retrieve that data from the mobile device. When mobile device 110 communicates with another device, such as computing device 114 (FIG. 1), the mobile device is associated with identifying information such as addressing information, presence information, and the like. For example, mobile device 110 can become associated with an internet protocol (IP) address, a MAC address, a network port, or any number of other types of addressing or locating information. IP addresses, MAC addresses, and others can be analyzed to ascertain information about the location of mobile device 110. Alternatively, mobile device 110 can utilize an address associated with a computing device, such as computing device 700 (discussed below with reference to FIG. 12), an internet service provider, a local area network, and the like. Communications can be monitored to detect, record, and analyze addressing information, presence information, and other types of information relevant to location information of mobile device 110. In yet another embodiment, geolocation module 124 may be installed on a computing device and the data from input module 120 may be transferred over a network or via other means to the geolocation module 124.

String module 128 uses as inputs the two or more places 104 recorded by geolocation module 124 and can generate or be configured to accept a relationship 112, via input module 120, based on the two or more places so as to develop string 116. Places 104 are connected by relationship 112, which can be articulated by a user or inferred by or transferred to a string module 128, for example, through a global network information system such as an internet-based webpage or an app. Relationship 112 can include a theme, a narrative, or a trait that is common to places 104 of string 116 or otherwise unites the places so as to produce a cohesive user experience. Some factors that can be used to establish relationship 112 between places 104 of string 116 include, but are not limited to, geolocations of each place 104, the temporal proximity between places, correlations between places, cost of or spending at each place, the timeframe associated with the string (total time to visit/access all places in the string), and/or the narrative supplied with the string that provides a description of the string experience. For example, temporal proximity of places 104 may be a component used to create a quality or type of experience intended by the author of string 116.

In another example, temporal proximity can be used to establish relationship 112 between places 104 in the event that one of the places is accessible to users only within a defined period of time. In one embodiment, string 116 entitled “An Afternoon in Asia” could include as place 104 an Asian exhibit at a local museum, followed by a formal tea service at a Japanese tea house. This embodiment of string 116 includes an Asian theme relationship 112 as described, optionally, by a narrative, which includes the string title, explaining the connection between the two places 104 and uniting the places through a theme. In this embodiment, places 104 may also share relationship 112 of temporal proximity that is defined by the hours of operation of the museum and the Japanese tea house and have a timeframe such that the user experience of engaging in the two events is further captured.

The connection between the author and a string 116 created by the author can be further enhanced using an author's profile, which in some embodiments, may also provide context and information to assist in forming relationship 112. For example, an author can provide a narrative or description characterizing the author's preferences, persona, profession, activities, age, marital status, home town, neighborhood, hobbies, etc. In another example, an author can use existing online information to provide or inform the profile. Existing online information can include a Facebook® profile, information as to friends, places, comments, and activities extracted from a Facebook account or other similar social media forum. In yet another example, information (including meta-data) from an author's mobile phone, smart phone, or computer can be extracted to contribute to a profile. For example, hobbies, locations of friends and family, and so forth can be extracted based on internet browsing history and phone number data. Once populated and periodically updated, the information in the profile can be used to establish relationship 112.

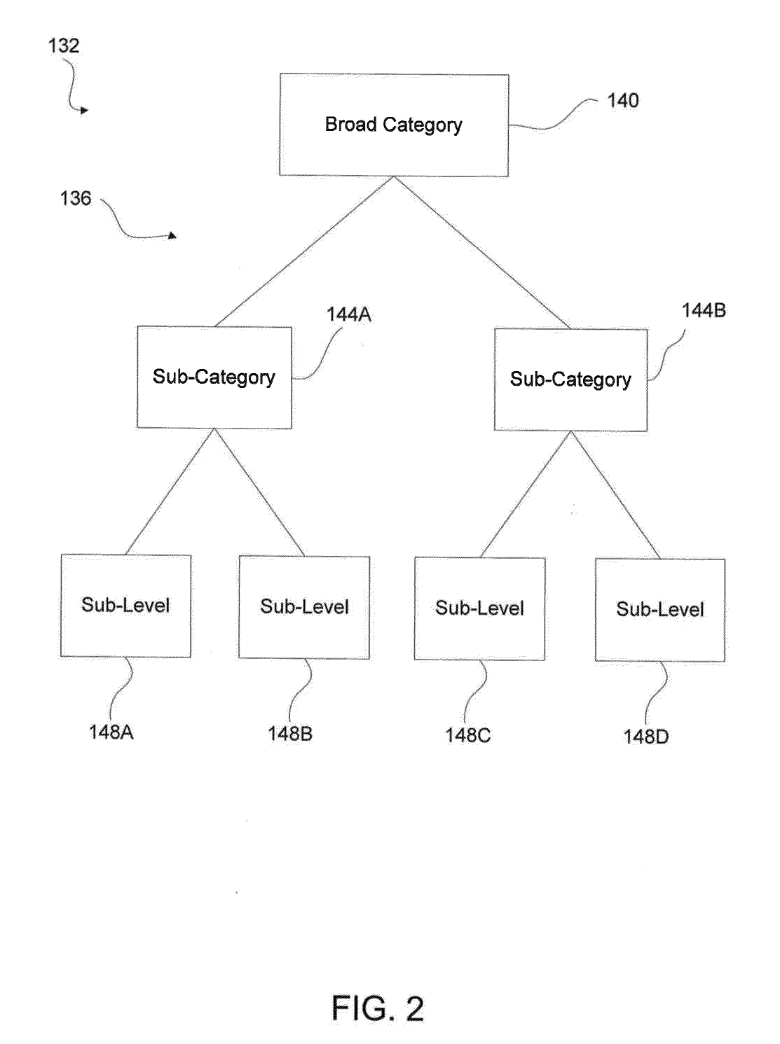

Relationships 112 can further be determined by categorizing traits of places and strings using a taxonomy system 132, shown in FIG. 2. In general, taxonomy refers to terms that may be associated with a place 104. In an embodiment, taxonomy system 132 can be structured to include a number of interrelated and associated category levels 136 that contain pre-defined place classifications. Category levels 136 are related such that a broad level category 140 includes one or more sub-categories 144, with, in certain embodiments, one or more sub-levels 148 disposed thereunder. This structure can be repeated to create a series of successively narrower sub-categories. For example, and as shown in FIG. 2, broad category level 140 could be “stores” with successively narrower sub-categories including “musical equipment stores” (sub-category 144A) with sub-levels including “piano stores” and “antique piano stores,” (sub-levels 148A-B, respectively) and “sports stores” (sub-category 144B) with sub-levels including “racquet sports” and ball sports, (sub-levels 148C-D, respectively). Classifications from broad category 140, any one or more sub-categories 144, or sub-levels 148 can then be assigned to places 104 or strings 116 to characterize the place, relationship 112 between places, or a string. Classifications can also be used to facilitate searching.

In addition to taxonomy, “folksonomy” can be used to develop an organization of places and strings using colloquial terminology and characterizations provided over time by users. In general, folksonomy does not initially include category levels 136, as the terms associated with the place are not predetermined. For example, a folkonomy can develop either through an affirmative solicitation by LBPS 100 for characterizations submitted by users or through an examination performed by the LBPS of user-provided narratives. In another example, LBPS 100 can search for and determine whether multiple users describe or characterize the same place 104 using recurring themes or terms. These recurring themes or terms can then be applied in the same way as a taxonomy 132, and used to describe or classify places 104, strings 116, authors, relationships 112, or the quality of experience.

String 116, as discussed above, includes at least two places having a unique location. In this context, the term “location” is intended to be defined broadly. That is, and in coordination with geolocation module 124, a location can include any geolocatable place. For example, a location can include an address of a physical place, whether a street address, an intersection name, a location identified by a landmark, or a GPS coordinate, also known as a geolocation position.

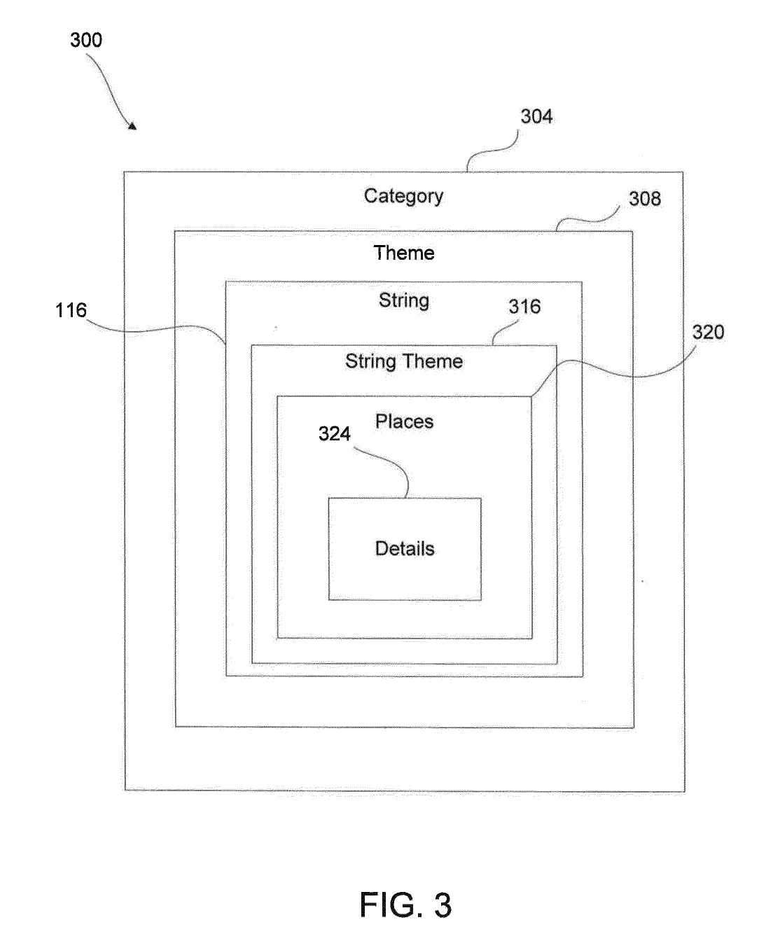

In some embodiments, places 104 and strings 116 can be hierarchically organized under themes and subthemes. FIG. 3 schematically depicts an example of such a hierarchical structure 300 for strings 116. String 116 presented to a user may be organized within one or more categories 304 within hierarchical structure 300. Each category 304 may, in some embodiments, have a unique theme 308 that is common to strings 116 within the category, but differs from the themes of the other categories. In other embodiments, the categories 304 in string 116 may have a similar theme or even the same theme. Similar to the diversity possible between the various categories 304, the strings 116 within a given category may also be distinct from each other while remaining consistent to the theme of the overarching category.

As shown in FIG. 3, each string 116 may include a unique string theme 316, wherein each string theme is consistent with the overarching category theme and the second theme of the hierarchical structure. As mentioned previously, strings 116 may include a plurality of places 320 (which may be places 104), e.g., visiting a garden, dining at a specified restaurant, and watching a show. As with strings 116 within category 304, places 320 may, in some examples, be diverse from each other, but nonetheless consistent with both the first theme of category 304 and the second theme of string 116. In some cases, it may be desirable to associate details 324 with one or more places 320, including, but not limited to, user comments, promotions and special offers, and the ability to invite others to a destination or string. As discussed more below, in some cases a user may provide details 324 and in other cases the details may be provided by the entity operating LBPS 100. In the former case, for example, a user may add an alternative destination to string 116, through suitable user interface functionality, e.g., input module 120, or a web-based database of places that are searchable and selectable by the user. In an embodiment, LBPS 100 is structured so that any additions to string 116 added by a user are consistent with the themes of the string 116 and category 304 in which the destination is added. In other embodiments, such limitation may not be desired. Interface functionality, included with, for example, mobile device 110, may also permit a user to rate the string and/or rate the author of the string, thereby providing additional information. Other details 324 may also be added to places 316, as those skilled in the art will appreciate.

Returning now to FIG. 1A, each relationship 112 includes one or more links 152. In general, links 152 are specific elements of relationship 116. For example, link 152 can be a temporal link between each place identified in the string. A temporal link can be important to certain types of strings 116 because the string may need to be completed within a certain time frame in order to properly characterize the user's experience at those places 104 or for other reasons. Additionally, for some strings 116, the sequence of events may require that certain places 104 be visited at certain times. For instance, if an exemplary string 116 include three places, such as, a restaurant, a park bench, and a comedy club, and the show at the comedy club has a certain start time, going to the restaurant and then the park bench would require a certain timing so as to afford a reviewer/re-creator of the string an opportunity to experience the relationship associated with the string. In another embodiment, link 152 may be physical proximity. In yet another embodiment, link 152 may be a theme or narrative designated by the user. In a further embodiment, link 152 may be a combination of one or more of the above referenced items.

LBPS 100 may also include a string search engine 156. String search engine 156 facilitates the searching of existing strings 116 located in a database associated with LBPS 100, such as a database included with content source 118 (FIG. 1). String search engine 156 may be configured to allow for searching of strings 116 using a variety of different criteria. For example, string search engine 156 may search existing strings 116 by the user who input the string. In another example, string search engine 156 may search existing strings 116 by place 104. In yet another example, string search engine 156 may search existing strings 116 by proximity to a desired location, for instance, if a searcher would like to view all of the strings located near a certain location or destination, e.g., Boston, Mass., Stowe, Vt., etc. In this example, string search engine 156 would return all strings 116 in the locale designated by the searcher. In yet a further example, string search engine 156 may allow a search by places 104 associated with a string 116. In this example, a place of interest would be input into string search engine 156 and the string search engine would return all of those strings 116 that included the place of interest. Further capabilities of a string search engine, such as string search engine 156, is described in U.S. patent application Ser. No. 13/274,051 to Meyer et al. and entitled “String Searching Systems and Methods Thereof”, which is incorporated by reference for its discussion of the same.

LBPS 100 may also include a correlation module 160. Correlation module 160 assists in determining various relationships or the strength of the relationships, also referred to herein as a strength value, between one or more places 104 or one or more strings 116 designated by a user. In an embodiment of correlation module 160, the correlation module can determine, based upon strings 116, a frequency of occurrence of a sequence of places 104 across multiple strings. The frequency of occurrence can indicate a strong or preferred relationship between two or more places 104.

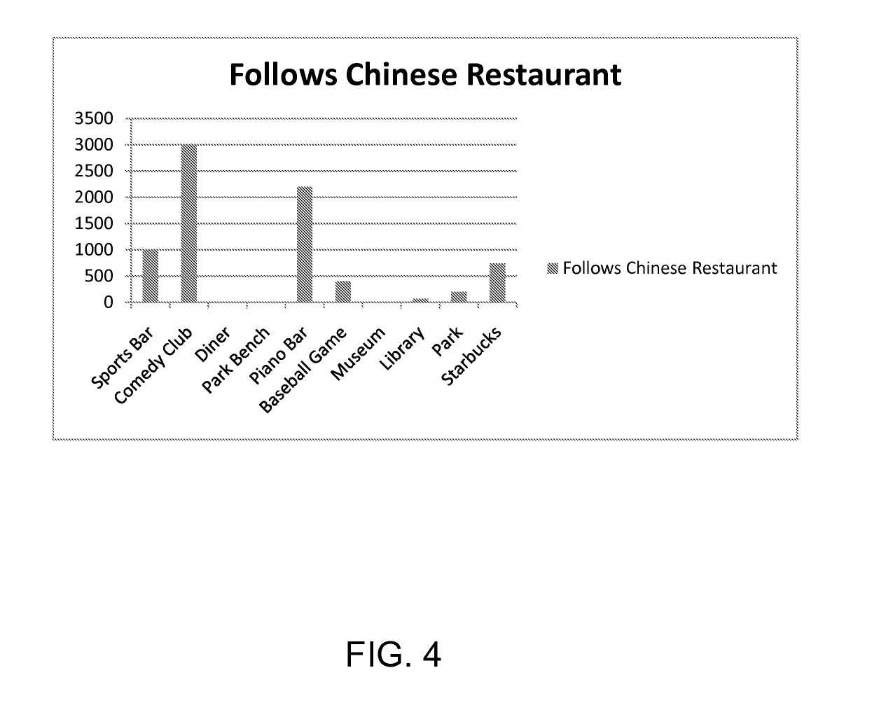

For example, and as shown in FIG. 4, a histogram displays the frequency of strings 116 that have in common at least one place 104, which, in this example, is a Chinese restaurant (the “Chinese restaurant strings”). The other places 104 included within the Chinese restaurant strings are, a sports bar, a comedy club, a diner, a park bench, a piano bar, a baseball game, a museum, a library, a park, and a Starbucks® coffee shop. As shown in the histogram in FIG. 4, the comedy club is the most frequently connected place to the Chinese restaurant. Correlation module 160 allows for this determination, which can subsequently allow for the suggestion of the comedy club to other persons using LBPS 100 who may be desiring an experience involving the Chinese restaurant and an additional place 104. Thus, a relationship 112 can be inferred via the use of correlation module 160, which based upon user behavior correlating two or more places 104.

For example, because a user can indicate his arrival at a first place 104 (Chinese restaurant) using mobile device 110, or such arrival can be automatically detected, LBPS 100 can make correlations using correlation module 160 to point the user to other places based on frequency and temporal proximity data sent by users. As another example, referring to the preceding embodiment, LBPS 100 can correlate the Asian exhibit at the museum with the Japanese tea house based on the frequency of user visits, and the temporal proximity between visits to places 104. This inferred relationship 112 can then be used for a number of purposes, including alerting the user of this previously unrecognized correlation or creating a string that includes the correlated places 104.

Returning to FIG. 1A, LBPS 100 may also include a promotions module 164. Promotion module 164 identifies a preferred string, groups of places, or relationship from among a corresponding plurality of strings, groups of places, or relationships between two or more geolocatable positions and associates a promotion with the preferred string, groups of places, or relationship. The preferred string, group, or relationship may be determined from by evaluating strength values associated with strings, which may come from several data sources including, but not limited to, business interests, POS data, user history, proximity, or other user history. Promotion module 164 may access a promotion database 168, which includes promotions and characteristics related to the promotion. Characteristics of the promotion can be the entity information related to the entity providing the promotion, the location of the promotion, a dollar value associated with the promotion, descriptive tag words about the promotion (e.g., trendy, pricey, famous, fashionable, bargain, etc.), or other types of information that would allow for association of a promotion with a string, place, or relationship.

Another example of a mobile device 110 including, among other things, a promotions module, such as promotions module 164, is shown in FIGS. 5-9. FIG. 5 shows mobile device 110 including a touch-sensitive display 404, an input device 408, a speaker 412, a transceiver 418, and one or more user-interface objects 420 (additional details regarding the components of the mobile device of FIGS. 5-9 are discussed further below). Touch-sensitive display 404 is sometimes called a “touch screen” for convenience, and may also be known as or called a touch-sensitive display system. Touch screen 404 can be used to display information or to provide user-interface objects 420 (e.g., virtual (also called “soft”) control keys, such as buttons or keyboards), thereby providing an input interface and an output interface between mobile device 110 and a user. Information displayed by touch screen 404 can include graphics, maps, text, icons, video, and any combination thereof (collectively termed “graphics”). In an embodiment, and in use with LBPS 100, a user can select user-interface object 420″ using touch screen 404 to request that mobile device 110 search for information, e.g., strings 116 or places 104, proximate the user's present location.

After selecting user-interface element 420″, mobile device 110 can send a request using transceiver 418 for information regarding the coordinates/location of the user and/or strings 116 and/or places 104 that can be associated with that location. For example, and as shown in FIG. 6, after selecting user-interface object 420″, mobile device 110 displays strings 116-1, 116-2, 116-3, 116-4, and 116-5. As described above, each string 116 has an associated relationship 112 and two or more places 104. Each string 116 can also have other characteristics such as, but not limited to, a descriptive label, narrative, photo, movie, promotion, or other media object. The organization of strings 116 on touch screen 404 can be prepared by several methodologies including, such as, but not limited to, proximity to the user, alphabetical, taxonomy, themes, folksonomy, or frequency. In an exemplary embodiment, and as shown in FIG. 6, the organization of strings 116 is based upon promotions received from promotion module 164.

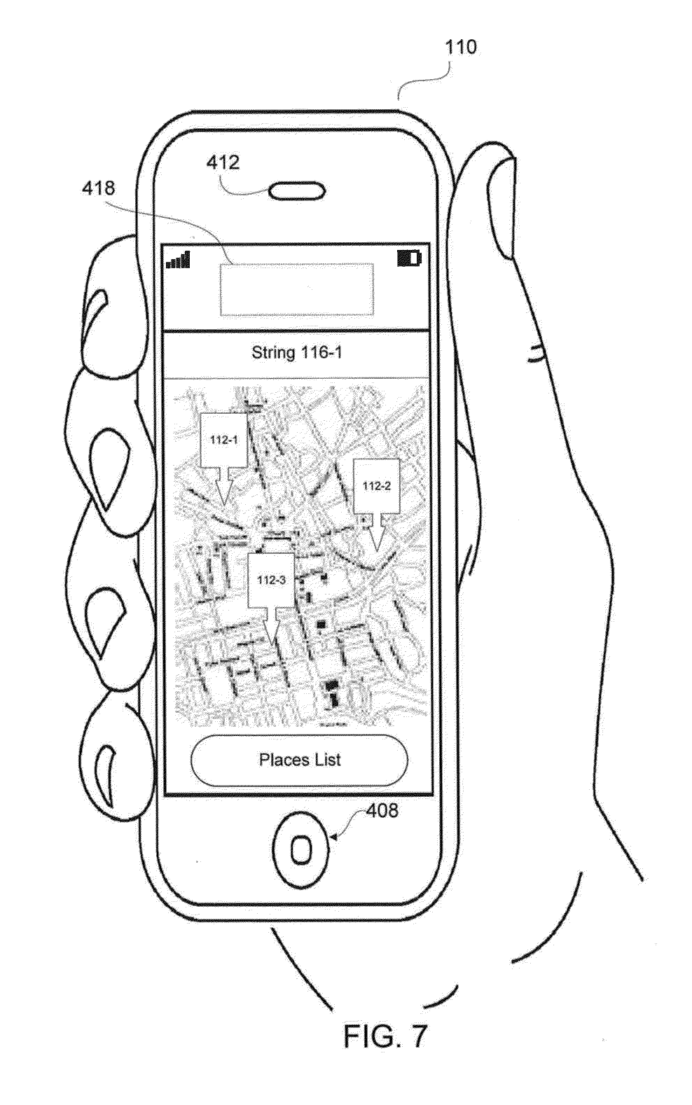

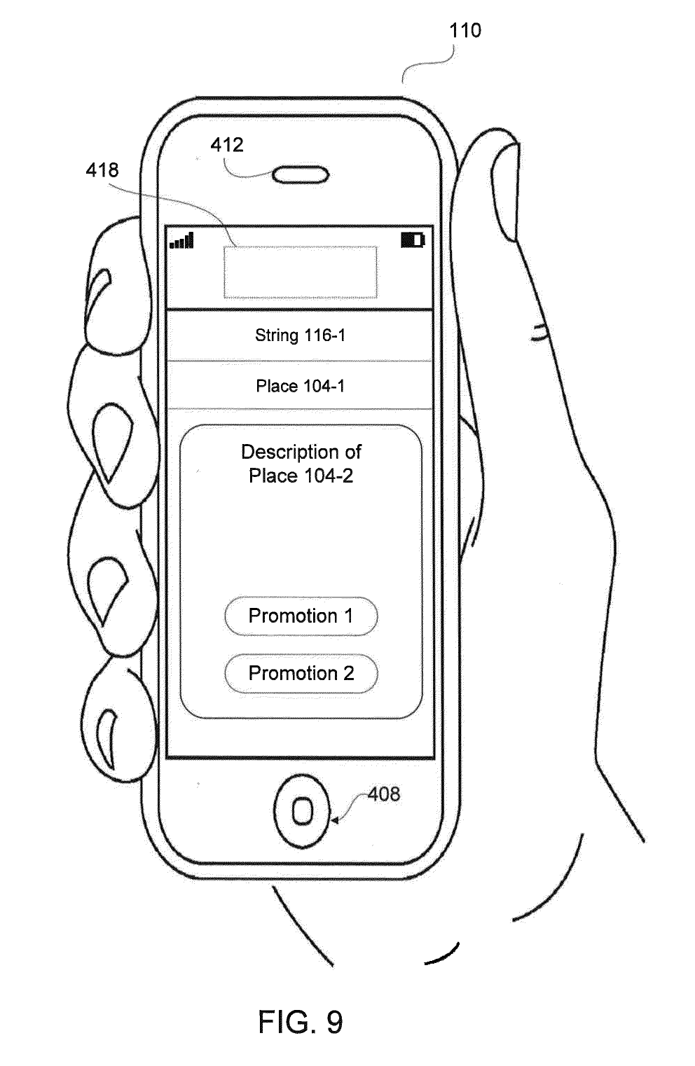

A user can select any one of the strings 116 shown on touch screen 404 by selecting the user-interface element 420 associated with the respective string. Selection of one of the aforementioned user-interface elements 420 can display more details associated with string 116. For example, and as shown in FIG. 7, if a user selects string 116-1 a map may appear that shows places 104-1, 104-2, and 104-3 that are included with the string. Additionally, each place 104 may have an associated label or description that may appear of the user selects the place. In an alternative embodiment, and as shown in FIG. 8, mobile device 110 may display a list of places associated with string 116-1, i.e., places 104-1, 104-2, and 104-3, which include details regarding each place. As shown in FIG. 9, selection of one of places 104 by the user can bring up even more detailed information associated with the place. For example, if place 104-2 is a restaurant, selection of the place can bring up address and other contact information, ratings, reviews, hours of operation, or other information relevant to the place. LBPS 100 may also return one or more promotions, such as promotions 424-1 and 424-2. Promotions 424-1 and 424-2 may be retrieved by promotions module 164 from promotions database 168 for display to the user.

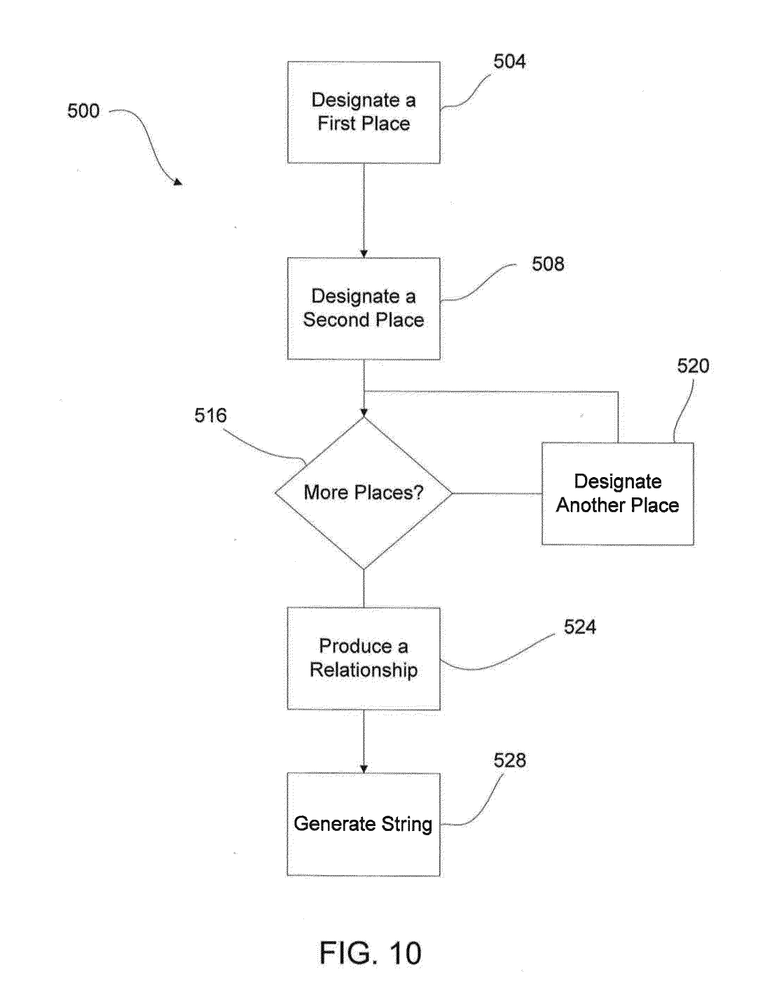

Turning now to FIG. 10, a method 500 of building a string with a mobile device, such as mobile device 110, or a computing device, such as computing devices 114 or 700, is depicted. At step 504 a first place is designated by a user. Such designation may occur when the mobile device is located at the first place and may be effected by the user taking an action with respect to a user interface element on the mobile device, as discussed more below. The first place can be any place having an address or geolocatable position. In an example, the first place has an associated with it a window, which is a time period in which the first place should be visited or accessed. The first place may also include entity related information. As discussed previously, entity related information can be information that is publically accessible via an information source (e.g., website) about the place. Examples of entity related information may be hours of operation, entity type, entity character, or entity services.

At step 508 a second place is designated by the users. As with the first place, such second place may be designated by the user when the mobile device is located at the second place. In the embodiment shown in FIG. 10, the second place is a place that does not include any entity related information. The second place can include, for example, a park bench, a tree, or a quiet spot along a river. As with the first place, the second place can also include a window. In some implementations, both the first and second places are designated when the mobile device is located, respectively, at the first and second places. In other implementations, just one of the first and second places is designated when the mobile device is located at such one place.

Designation of the first place or the second place may be made using a user interface element 420′ (FIG. 5) presented on a touch screen or other input device available on mobile device 110. For example, upon arrival at the first place, a user may designate the first place by tapping a soft button displayed on the touch screen of the mobile device, at which point the mobile device can use a geolocation module to determine the location, e.g., coordinates, address, etc., of the place. In this way, first place and second place may be any geolocatable place to which a user may travel.

At step 512, a determination as to whether more places should be included prior to generation of a string, such as string 116. If further places are to be included, the process proceeds to step 516, where another place is designated. The additional places may or may not include entity related information as appropriate for the place designated by the user. If no further places are to be designated, the process proceeds to step 520.

At step 520, a relationship, such as relationship 112, is produced. Production of the relationship can encompass associations between the first place and the second place, such as, but not limited to, physical proximity of the first and second place, the characteristics of the first place and the second place, the overall time (also referred to as timeframe) for visiting or accessing the first place and the second place, and the association of the respective windows for visiting or accessing the first place and the second place, or correlations based upon the first place or second place. For example, a user that designates a first place, such as a restaurant having a window of between 5 pm and 7 pm, and second place, such as a scenic overview point for watching a sunset having a window of 7:30 pm and 8:30 pm, can have a relationship including, for example, a timeframe of between 5 pm and 8:30 pm, a distance between the first place and second place, and/or the sequence and timing (i.e., windows) of each place such that an experience of the user may be created and recreated by the user or others.

At step 524, a string, such as string 116, is generated. The string is generated based upon the first place, the second place, and the associated relationship produced in step 520. The string represents an experience of the string author that has a quality, character, and/or feel intended by the string author.

In an embodiment of process 500, the string generated in step 524 may be further processed. For example, the string may be stored in a database, the database suitable for storing tens of thousands, if not millions, of strings or more. This initial string may then be compared to other strings in the database. The comparison may allow for the initial string to be categorized among other strings such that the other strings may be suggested to the author of the initial string. Alternatively, and as discussed above, the comparison may involve determining a frequency of occurrence of the two places or types of relationships that occur.

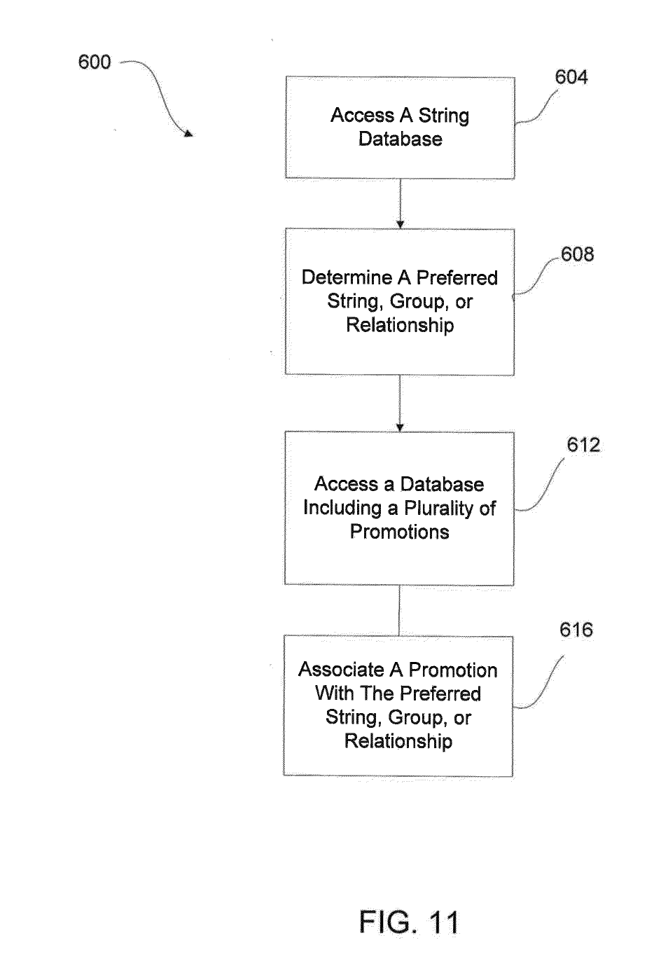

FIG. 11 shows a promotion association process 600 suitable for connecting one or more promotions with a preferred string or preferred group of places. At step 604, process 600 accesses a database that includes a plurality of strings. As discussed above, each string in the database includes a relationship.

Alternatively, while in some instances a group of places may coincide with a complete string, such as when there are only two places in a string, the groups of places may also be only a portion of a string. For example, if the string includes four places, e.g., place A, B, C, and D, the relationship associated with the string may be attributed to all of the potential groups of places and additional relationship characteristics may be generated between Group 1: places A and B, Group 2: places B and C, Group 3: places C and D, Group 4: places A and D, Group 5: places A and C, Group 6: places B and D, Group 7: places A, B, and C, Group 8: places A, C, and D, and Group 9: places B, C, D. In this embodiment, nine groups in addition to the string may be established corresponding to at least two places and the relationship between the two places.

At step 604, a preferred string or preferred group of places is determined. The determination of the preferred string or preferred group of places can be completed using a frequency analysis using, for example, correlation module 160. Alternatively, the preferred string or group can be determined using point of sale data, which may be an indicator of a preferred location or group of locations. In yet another embodiment, the preferred string may be identified using geolocation data (e.g., geographical proximity), temporal proximity, narratives, and other characteristics of the places and strings discussed above.

At step 608, a database of promotions is accessed. The databases of promotions includes promotional materials, such as, but not limited to, coupons, gifts, credits, and special offers, that are associated with one or more places. The database may further include other types of characteristics of the promotion such as, the value of the promotion, one or more descriptions of the promotion (e.g., drinks, meals, clothing, jewelry, etc.), and/or an experience associated with the promotion. The experience associated with the promotion may be chosen by a entity so as to market to a certain type of user of the promotional association system.

At step 612, a promotion from the promotions database is associated with the string or preferred group of places. The selection of a promotion may be based upon a similarity evaluation, for example, the evaluation of place similarities (a comparison between the characteristics of the place in the promotion and the places in the string), taxonomy or folksonomy similarities between the promotion and the string, point of sale information (e.g., a string that results in a significant amount of money spent may be associable with a promotion for high end restaurants or stores), or types of purchases made (e.g., a Nike® shoe purchase may provoke an association with a Nike promotion).

The amount of similarity between the characteristics of the promotion and the string or groups may be variable. In an exemplary embodiment, the association between the promotions and strings are refined using feedback from the user. For example, a user may decline to use a promotion or otherwise indicate that the promotion is not sufficiently associated with the place or string to be meaningful to the user. In this way the promotions association process 600 (or promotions module 164) can better tailor results to the user. The feedback can be used to improve the system wide promotions associations process 600 or promotions module 164 or can be limited to tailored results only for the user that initiates the feedback.

It is to be noted that any one or more of the aspects and embodiments of processes 500 or 600 and/or LBPS 100, as described herein, may be conveniently implemented using one or more machines (e.g., one or more mobile devices 110 or one or more computing devices 114) programmed according to the teachings of the present specification, as will be apparent to those of ordinary skill in the computer art. Aspects and implementations of LBPS 100, discussed above, employing software and/or software modules may also include appropriate hardware for assisting in the implementation of the machine executable instructions of the software and/or software module.

Returning to discuss the details of mobile device 110, touch screen 404 has a touch-sensitive surface, which uses a sensor or set of sensors to accepts input from the user based on haptic and/or tactile contact. Touch screen 404 may use LCD (liquid crystal display) technology, or LPD (light emitting polymer display) technology, although other display technologies may be used in other embodiments. Touch screen 404 can detect contact (and any movement or breaking of the contact) on the touch screen and converts the detected contact into interaction with user-interface objects (e.g., one or more soft keys, icons, web pages or images) that are displayed on the touch screen. Touch screen 404 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 404. In an exemplary embodiment of the use of mobile device 110, a user presses a finger to touch screen 404 so as to initiate contact. In alternative embodiments, a user may make contact with touch screen 404 using any suitable object, such as, but not limited to, a stylus.

Input device 408 facilitates navigation among and interact with one or more user-interface objects 420 displayed in the touch screen 404. In an embodiment, input device 408 is a click wheel that can be rotated or moved such that it can be used to select one or more user-interface objects 420 displayed on touch screen 404. In an alternative embodiment, input device 408 can be a virtual click wheel, which may be either an opaque or semitransparent object that appears and disappears on the touch screen display in response to user interaction with mobile device 110.

Transceiver 418 can receives and sends signals from information system 102 or computing system 600 (described in more detail below). In an embodiment of mobile device 110, transceiver 418 sends and receives radio frequency signals through one or more communications networks, such as network 106 (FIG. 1), and/or other computing devices, such as computing device 114. Transceiver 418 may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, transceiver 418 may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Mobile device 110 may use any of a plurality of communications standards to communicate to networks or other devices with transceiver 418. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol.

Transceiver 418 may also be configured to assist mobile device 110 in determining its current location. In an exemplary embodiment, mobile device 110 includes a geolocation module, such as geolocation 124 (FIG. 1A). In this embodiment, the geolocation module provides signals to transceiver 418 that are suitable for determining the location of mobile device 110, as discussed in detail above.

It should be appreciated that the mobile device 110 is only one example of the mobile device that may be used with the present system and method, and that the mobile device may have more or fewer components than mentioned, may combine two or more components, or a may have a different configuration or arrangement of the components. In the present system and method, mobile device 110 be implemented with any computing device that includes geolocation functionality and is not so large that it is very inconvenient to move it from one location to another. Thus, mobile device 110 is not restricted to a smartphone or other hand-held device, and may include pad or tablet computing devices, smart books, net books, laptops, and even larger computing devices with geolocation functionality that may be moved from one location to another without significant inconvenience.

FIG. 12 shows a diagrammatic representation of one embodiment of a computing device 114 or mobile device 110 in the exemplary form of a computing system 700, within which a set of instructions for causing a processor 704 to perform any one or more of the aspects and/or methodologies, such as process 500 and/or process 600, of the present disclosure. It is also contemplated that multiple mobile devices or combinations of computing devices and mobile devices may be utilized to implement a specially configured set of instructions for causing LBPS 100 to perform any one or more of the aspects and/or methodologies of the present disclosure.

Computing system 700 can also include a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Memory 708 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 716 (BIOS), including basic routines that help to transfer information between elements within computing system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computing system 700 may also include a storage device 724, such as, but not limited to, the machine readable storage medium described above. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with mobile device system 700 (e.g., via an external port connector (not shown)). Particularly, storage device 724 and an associated machine-readable medium 728 may provide nonvolatile and/or volatile storage of machine-readable instructions, data structures, program modules, and/or other data for computing system 700. In one example, software 720 may reside, completely or partially, within machine-readable medium 728. In another example, software 720 may reside, completely or partially, within processor 704.

Computing system 700 may also include an input device 732, such as touch screen 404, input device 408, or other internal or external input devices. Additional examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computing system 700 via storage device 724 (e.g., a removable disk drive, a flash drive, etc.) and/or network interface device 740. A network interface device, such as network interface device 740 may be utilized for connecting computing system 700 to one or more of a variety of networks, such as network 744 or networks 106 of FIG. 1, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 744, may employ a wired and/or a wireless mode of communication. In general, any network topology may be used. Information (e.g., data, software 720, etc.) may be communicated to and/or from computing system 700 via network interface device 740.

Computing system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide a graphical representation of a utility resource, a location of a land parcel, and/or a location of an easement to a user. In addition to a display device, computing system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The various components shown in herein may be implemented in hardware, software or a combination of both hardware and software, including one or more signal processing and/or application specific integrated circuits. Software, as discussed above, may be a computer program product that employs a machine-readable storage medium. A machine-readable storage medium may be any medium that is capable of storing and/or encoding a sequence of instructions for execution by a machine (e.g., mobile device 110) or a portion of the machine and that causes the machine to perform any one of the methodologies and/or embodiments described herein. Examples of a machine-readable storage medium include, but are not limited to, a magnetic disk, an optical disk, a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine and any related information (e.g., data structures and data) that causes the machine to perform any one of the methodologies and/or embodiments described herein.

Exemplary embodiments have been disclosed above and illustrated in the accompanying a be understood by those skilled in the art that various changes, omissions and additions may be made to that which is specifically disclosed herein without departing from the spirit and scope of the present invention.

What is claimed is:

1. A promotion system for connecting a consumer to a promotion comprising:
a computer-readable storage medium having a database and executable computer program instructions for electronic analysis of a plurality of places stored in said database, the computer program instructions including:
a string module configured to develop at least one relationship for respective groups of said plurality of places; and
a promotions module configured to determine a preferred string from a plurality of strings, said preferred string including at least two of said plurality of places and to associate a promotion with one or more places included with said preferred string.

2. A promotion system according to claim 1, wherein said preferred string is identified by evaluating recurrences of said plurality of strings.

3. A promotion system according to claim 1, wherein said promotions module includes a strength value to identify said preferred string.

4. A promotion system according to claim 3, wherein said strength value is a recurrence value.

5. A promotion system according to claim 3, wherein said strength value is a temporal proximity value.

6. A promotion system according to claim 3, wherein said strength value is a similarity value, wherein said similarity value is a similarity evaluation of a description of the relationship provided by a plurality of consumers.

7. A promotion system according to claim 6, wherein said promotion module selects said promotion from a plurality of promotions based upon a similarity evaluation of characteristics associated with the promotion and said at least one relationship.

8. A promotion system according to claim 3, wherein said strength value is a sale value, said sale value being a total of the purchases made at one of said plurality of locations associated with said preferred string.

9. A promotion system according to claim 3, wherein said promotion module is further configured to deliver said promotion to the consumer when the consumer selects the preferred string.

10. A method of identifying potential consumers of a product or service using a database including a plurality of groups of places, the method comprising:
generating a relationship for each of the plurality of groups of places;
determining a preferred group from among the plurality of groups of places; and
associating the preferred group with one or more promotions for products or services related to places within the preferred group.

11. A method according to claim 10, further comprising providing the potential consumer with the one or more promotions when the consumer is at a first one of the plurality of places associated with the preferred group.

12. A method according to claim 10, wherein the group includes a strength value.

13. A method according to claim 12, wherein the one or more promotions is assigned to the preferred group based upon said strength value.

14. A method according to claim 12, wherein the strength value is based on temporal proximity.

15. A method according to claim 12, wherein the strength value is based on a point of sale transaction.

16. A method according to claim 12, wherein the strength value is based on an attribute defined by the consumer.

17. A method according to claim 12, wherein the strength value is further based on physical proximity of the plurality of places.

18. A method according to claim 12, wherein said providing step includes identifying similar products or services that may be of interest to the consumer based upon the relationship associated with the preferred group, wherein the similar products and services are at places that the consumer has not previously visited.

19. A method according to claim 18, wherein said providing step further includes providing an incentive to the consumer such that when the consumer visits a first place associated with the preferred group, the incentive induces the consumer to visit a second, previously unvisited, place.

20. A promotion system comprising:
a mobile device including a computer-readable storage medium having a database and executable computer program instructions for electronic analysis of a groups of places stored in said database, the computer program instructions including:
a geolocation module configured to determine a location of said mobile device;
a promotions module configured to determine a preferred group based upon said location of said mobile device and to associate a promotion with one or more places included with said preferred group.

21. A promotion system according to claim 20, wherein the computer program instructions further include a string module configured to develop a relationship for said groups of places, wherein each of said groups of places is associated with a respective consumer and are proximate said location.
